(19) United States
(12) Patent Application Publication
(10) Pub. No.: US 2005/0044231 A1
(43) Pub. Date: Feb. 24, 2005

(54) Client/supplier communication and performance management system

(76) Inventor: Boris Apotovsky, Encinitas, CA (US)

Correspondence Address: NEIL K. NYDEGGER;NYDEGGER & ASSOCIATES, 348 Olive Street, San Diego, CA, 92103, US

(21) Appl. No.: 10/637,119

(22) Filed: Aug. 8, 2003

(51) Int. Cl. G06F 7/00; G06F 17/00; G06F 15/173; G06F 15/16

(52) U.S. Cl. 709/227; 709/228; 709/223; 707/104.1

(57) ABSTRACT

An internet-based system for transferring dynamic information from a service provider to an entity includes an icon at the entity's workstation for directing the entity to a communicator at the web site of the service provider. Further, the communicator directs the entity to interconnected modules at the web site of the service provider where categorized aspects of the dynamic information are respectively presented for collective use by individual modules. Specifically, this information concerns the performance status of specific tasks necessary for the completion of a defined project for the particular entity.

### FIELD OF THE INVENTION

The present invention pertains generally to communications systems and methods for transferring information from one party to another. More particularly, the present invention pertains to systems and methods for transferring information that pertains to the status of defined work projects or predetermined tasks. The present invention is particularly, but not exclusively, useful as a communication system and method which accesses a plurality of disparate databases for transferring updated, time-variable information on the status of specific tasks being performed by a service provider.

### BACKGROUND OF THE INVENTION

With the introduction and general acceptance of a global communications system (i.e. the so-called internet), the transfer of information and data between parties has in many instances been simplified, facilitated, and even expedited. In one aspect, use of the internet has allowed individual parties to interact directly with each other for any of a variety of reasons or purposes. For example, the internet has given both individual and institutional vendors a forum in which to commercialize their respective goods and services. On the internet, this is done by either advertising or through the actual conduct of specific transactions.

Insofar as goods are concerned, a transaction over the internet can be fairly straightforward. Specifically, the vendor can use a website to present the particular product that is being sold. In this case, the vendor will also provide information as to what a buyer must do to purchase the product. Services, however, are not necessarily so straightforward.

Heretofore, the provision of services over the internet has generally involved the transfer of informational, educational or entertainment materials to the general public. One method commonly used for such transactions has been through the device of subscription services. Such services are identifiable and are provided on the same basis to all members of the general public. It happens, however, that many services require they be customized for the particular individual or entity that is being served.

In general, customized services are services that are tailored to the particular needs of an individual or entity. Typically, this requires the individual give the service provider information pertaining to his/her needs. With this information, the service provider can then customize the service. Stated differently, the service that is provided is determined by the needs of the individual receiving the service; as these needs are described and defined by the individual receiving the service. It happens, however, that some customized services are not determined by the individual or entity for whom the service is provided.

Many situations can be identified wherein one party is employed by another party to perform a particular identifiable task or project. In all such situations, the employee who is performing a task, or doing work on a project for the employer, can provide the employer a valuable service by keeping the employer informed about such matters as the progress of work, the timely completion of tasks, work stoppages and necessary deviations from the work plan or schedule. This information, however, may be held in several disparate databases. Thus, in order that all of the important information pertaining to a specified task be available on demand, it may be necessary to have accessibility to several different databases. The present invention recognizes the desirability and feasibility of providing such service.

In light of the above, it is an object of the present invention to provide an internet-based system wherein time-variable information in different databases that is collectively pertinent to the performance status of specific tasks undertaken by a service provider can be integrated and periodically updated, while being easily accessed and customized by a client/customer. Another object of the present invention is to provide a system that gives a visual notification to the individual or entity being served whenever pertinent time-variable information has been updated. Still another object of the present invention is to provide a system that directs an individual or entity being served to updates on information specifically dedicated to the individual or entity. Another object of the present invention is to provide performance related statistical information to measure overall performance and provide a measure for self-improvement. Yet another object of the present invention is to provide an internet-based system which is easy to use, simple to implement and relatively cost effective to operate.

### SUMMARY OF THE INVENTION

An internet-based system for transferring dynamic time-variable information from a service provider to an entity includes a remote workstation which has a browser. This remote workstation is specifically used by the entity to access sites on the internet. Further, the system includes a communicator that is operated by the service provider as a site on the internet. When the remote workstation is connected to the communicator via the internet, dynamic time-variable information that is held in a variety of disparate databases, and that collectively pertains to the performance status of specific tasks undertaken by the service provider, are available for use by the entity.

In more detail, the system of the present invention includes an icon that is provided at the remote workstation. Specifically, this icon is provided to connect the remote workstation with the communicator. The icon can be customized with a logo that is provided by the service provider, and it will include login and password information regarding the entity. Thus, the communicator is readily accessible from the remote workstation. On the other hand, an auxiliary remote workstation or a wireless remote workstation can be used for accessing the communicator if login and personal information regarding the entity, as well as URL information regarding the service provider are submitted to the communicator.

In accordance with the present invention, the transfer of the time-variable information from the service provider to the individual or entity can be done through selected modules. Specifically, information for a particular individual or entity can be presented in a plurality of modules at the communicator. These modules are provided by the service provider and are accessible by the entity for display at the base workstation. More specifically, a database at each module contains categorized aspects of the dynamic time-variable information that is pertinent to a titled category. For example, the titled categories can include such disparate information as Customer Profile, Help/Request Desk, Customer Update, Customer File (file storage), Complaint Manager, Survey Manager, and Meeting Minutes. Further, the databases of the individual modules are interconnected with each other so that an increased amount of data can be accessed for each task.

An important aspect of the present invention is that it includes electronics that will cause the icon to blink at the remote workstation whenever the service provider updates the dynamic, time-variable information. More specifically, these electronics activate a link for selectively leading the individual or entity being served to the updated dynamic time-variable information. If desired, however, the individual or entity can by-pass the updating link. As an add-on feature, the service provider can display static information on the communicator for viewing by the individual or entity, when the defined project has been completed and the individual or entity is no longer being served. Also, when each task has been completed, a customer/client can comment on the performance of the supplier/service provider, and this information can be stored in an appropriate database for possible future use.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic diagram of a system of the present invention;

FIG. 2 is an exemplary layout of time variable information provided by the system of the present invention;

FIG. 3 is a schematic diagram of exemplary components in a quality assurance module; and

FIG. 4 is a schematic diagram of an extended system for the present invention.

### DESCRIPTION OF THE PREFERRED EMBODIMENTS

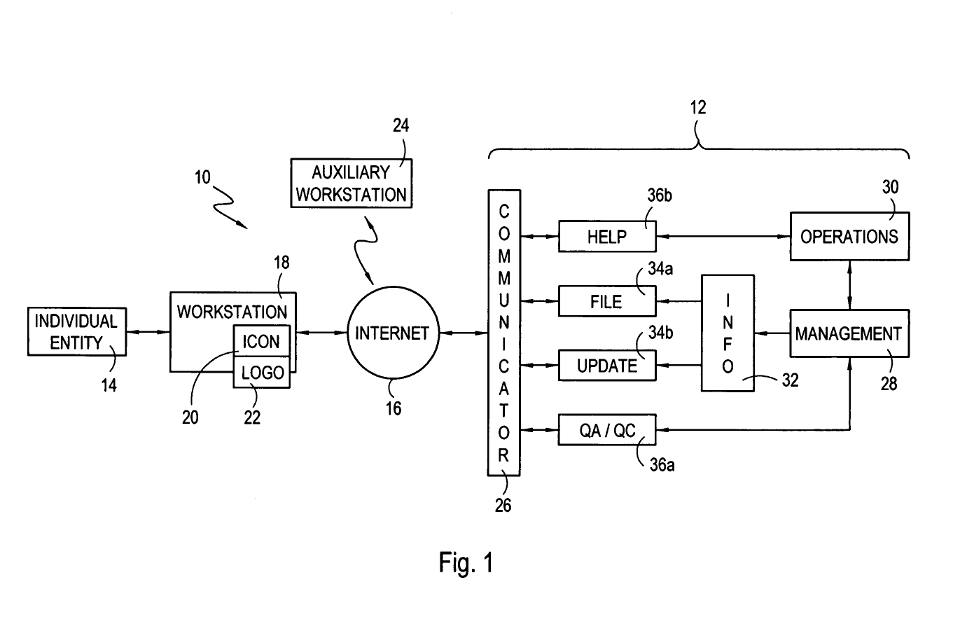

Referring initially to FIG. 1, a schematic diagram of the system of the present invention is shown and is generally designated 10. In general, the system 10 is used to transfer information from a service provider 12 to an individual/entity 14 over the internet 16. More specifically, the system 10 is used to transfer dedicated information from a service provider 12 to a particular individual/entity 14. Thus, although the service provider 12 may communicate with other individuals/entities 14 over the internet 16, each individual/entity 14 will, in effect, have its own customized system 10.

As shown in FIG. 1, the individual/entity 14 that is using the system 10 will have a workstation 18 that is in communication with the internet 16. An icon 20, and a logo 22 are displayed at the workstation 18 for identification and interconnect purposes. More specifically, the icon 20 is a marketing tool of the service provider 12 that allows the individual/entity 14 to communicate directly and constantly with the service provider 12. For this purpose, the icon 20 includes login and password information pertaining to the particular individual/entity 14 that allows for pre-verified communications connections between the individual/entity 14 and the service provider 12. Further, the icon 20 can provide information on the status of a task. For instance, color changes at the icon 20 can indicate the current status of a project or task. On the other hand, the individual/entity 14 can use an auxiliary workstation 24 having no icon 20 and still communicate with the service provider 12. In this case however, because security information is needed, if the auxiliary workstation 24 does not have an icon 20, the individual/entity 14 will need to input the required login and password information. The auxiliary workstation 24, which may be wireless, will communicate with the service provider 12 over the internet 16, much like the workstation 18.

A central feature of the system 10 is a communicator 26 which is a customized interface that allows the service provider 12 to directly interact with the individual/entity 14. In general, the communicator 26 is an integration tool that allows data from different sources to be used collectively. As shown, the communicator 26 gives personnel of management 28 and operations 30 of the service provider 12 the wherewithal to pass specific information 32, as well as general assistance advice, to the individual/entity 14. As envisioned for the present invention, information 32 is unique in that it is dedicated specifically to the individual/entity 14. Further, and importantly, the information 32 is dynamic in the sense it is changing and, therefore, time variable. This latter aspect of the information 32 requires that in order for the information 32 to be accurate, it needs to be periodically updated whenever changes are made. As also envisioned for the present invention, the information 32 can include greetings and statistical information, such as charts, as well as present visual/pictorial information about a site, a person, or some other information aspect of interest. For example, the communicator 26 can be presented as a tool bar with a statistical screen and have buttons that change color to reflect the current status of a particular task. In sum, the communicator 26 is an integration engine that will integrate the various databases 44,46 including messaging and digital fax systems.

Due to the significance of the information 32, and recognizing the need to maintain its pertinence, the system 10 categorizes this information 32. Specifically, the information 32, as well as other information for interactive communications with the individual/entity 14, are categorized into informational modules 34 and interactive modules 36, respectively. Both the modules 34 and 36 are similar in that they contain information that is dedicated to the particular individual/entity 14. Collectively, they give the individual/entity 14 the ability to monitor and comment on the status of tasks or work being done for the individual/entity 14 by the service provider 12.

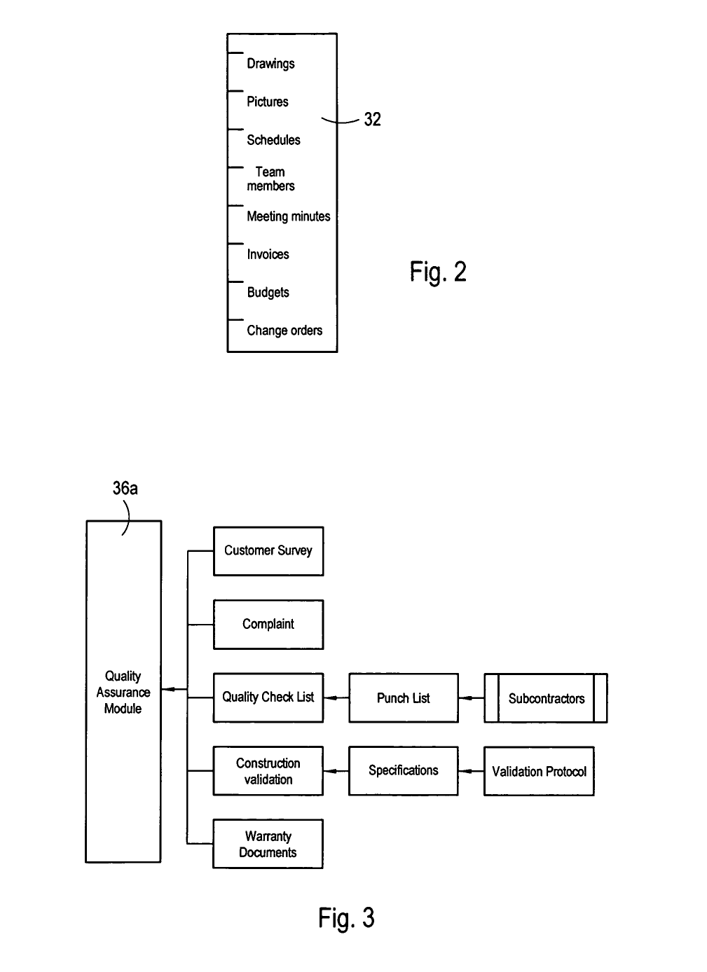

In detail, the information modules 34a and 34b shown in FIG. 1 are exemplary of consolidated information 32 as it pertains to the completion or status of specific work projects. For example, FIG. 2 identifies possible components of information 32 that would be useful for completing particular task(s). The consolidation of this information is then presented to the communicator 26 in the module 34a. At the same time, updates (i.e. changes) pertaining to additions, deletions or modifications for this information 32 are presented to the communicator 26 in the module 34b.

The modules 36a and 36b shown in FIG. 1 are exemplary of information that involves interactions between the individual/entity 14 and the service provider 12. Specifically, the module 36a is shown as interactive information that pertains to quality assurance and quality control (QA/QC). The module 36b is shown to represent information that pertains to requests and inquiries that may be made by the individual/entity 14. An example of the type of interactive information available in module 36a is shown in FIG. 3.

An additional feature of the system 10 is that the service provider 12 can immediately notify the individual/entity 14 when the module 34b includes updates. Specifically, this notification is made by causing the icon 20 at the workstation 18 to begin blinking or change color. The individual/entity 14 can then access the module 34a through the communicator 26. The individual/entity 14 may, however, by-pass the module 34a and, instead, access other information 32 or interactive information, as desired. In any event, the overall purpose of the system 10 is to provide an individual/entity 14 with accurate, precise, and timely information about the progress and status of work projects that are being done by the service provider 12 for the individual/entity 14.

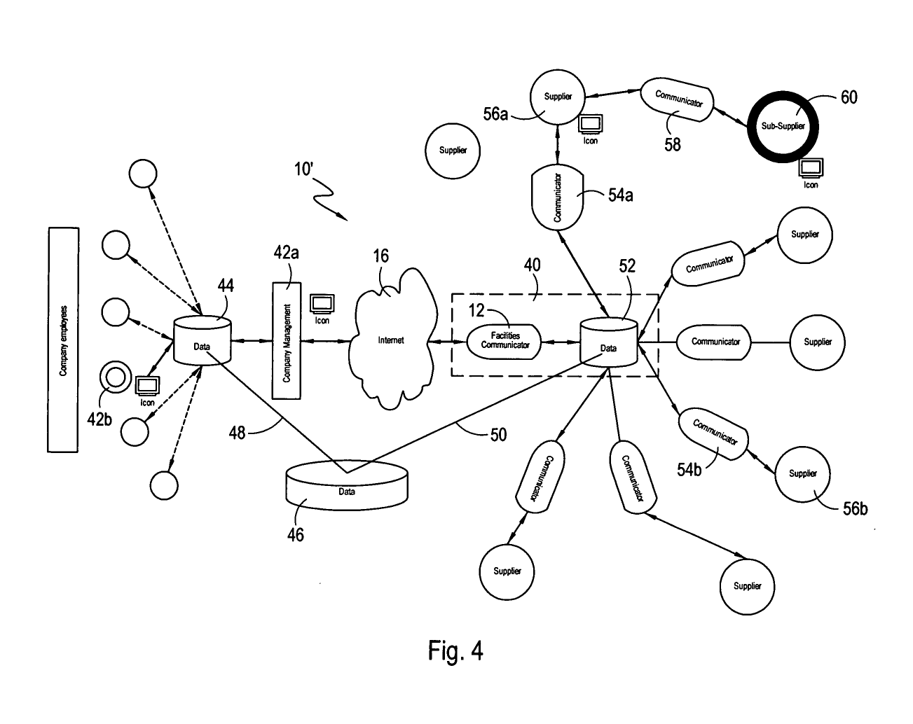

Referring now to FIG. 4, a representative overview system for the present invention is shown and is generally designated 10′. Central to the system 10′ is a base facility 40 which includes a service provider 12, such as the one previously disclosed. As shown, the base facility 40 can be connected directly onto the internet 16.

In accordance with the system 10′ shown in FIG. 4, it is intended that the system 10′ provide each customer (entity) 42 with the ability to access the base facility 40. Although the customers 42a and 42b shown in FIG. 4 are only exemplary, it is anticipated for the system 10′ that many such customers 42 may share a common database 44. On the other hand, they may each have individual databases. In either case, all of these databases are, preferably, interconnected into the system 10′.

Insofar as databases are concerned, FIG. 4 shows that the database 44, which is used by the customers 42, may be connected with other, remote databases, such as the database 46. Connections between databases 44 (on site) and remote databases 46 (off site) can be by any type of appropriate communications link 48. Additionally, the off site databases 46 can be connected via appropriate communications links 50 with a central database 52 that is located at the base facility 40. Importantly, the central database 52 will include, or be further augmented by, individual databases at each of the modules 34, 36 in the service provider 12.

As contemplated by the system 10′, the database 52 is electronically connected with various communicators 54 (the communicators 54a and 54b are only exemplary) so that respective suppliers 56a,b can access the base facility 40. Further, as shown in FIG. 4, additional communicators (e.g. communicator 58) can be connected into the system 10′ so that additional suppliers (e.g. sub-supplier 60) can function in the system 10′. In each case, the communicator 54, 58 will include selected modules 34, 36, along with a dedicated database, that will allow them to interact with other modules 34, 36, and their respective databases, in the system 10′. Thus, the system 10′ of the present invention provides for a multi-tier communications system.

It is an important aspect of the system 10′ of the present invention that each communicator 54, 58 includes modules 34, 36 to perform appropriate tasks/functions. Moreover, each module 34, 36 has its own database, as well as access to all other databases 44, 46, 52 in the system 10′ for the performance of these tasks/functions.

While the particular Client/Supplier Communication and Performance Management System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A system for establishing communications between a client and a service provider which comprises:
a plurality of databases for respectively storing collected information;
a base facility;
a plurality of disparate modules interconnected with each other at said base facility, wherein each said module has a dedicated database and is integrated with other said databases in said plurality of databases for use of the collected information therein when performing a specified task;
a facility communicator for use by the client to access a selected said module at said base facility; and
a source communicator for use by the service provider when communicating with the client through one said module for performance of the specified task.

2. A system as recited in claim 1 wherein said plurality of modules comprises:
at least one information and communication module for managing and analyzing the performance of the specified task; and
at least one support module for expediting and verifying the implementation of the specified task.

3. A system as recited in claim 2 further comprising an error correction module having an error database.

4. A system as recited in claim 2 wherein one said information and communication module is a Help/Request/Task module comprising:
a means for accessing a predetermined entity of the service provider;
a means for accessing a predetermined entity of the customer;
a means for approving and forwarding information from one said entity to another said entity;
a means for tracking and managing the performance of the specific task; and
a means for updating the collected information.

5. A system as recited in claim 2 wherein one said support module is a Survey module comprising:
a means for analyzing the collected information in said plurality of databases over a defined time period;
a means for combining and comparing the collected information; and
a means for defining a set of criteria for evaluating the collected information.

6. A system as recited in claim 5 wherein said set of criteria comprises:
client categories;
comment categories;
survey categories;
number of occurrences;
number of occurrences per client category; and
number of occurrences per survey category.

7. A system as recited in claim 1 wherein said plurality of databases comprise:
a service provider performance database;
a client satisfaction database;
a maintenance database;
a best practices database; and
an error database.

8. An internet-based system for transferring dynamic time-variable information from a service provider to an entity, wherein the dynamic information pertains to the performance status of specific tasks undertaken by the service provider for the completion of a defined project, the system comprising:
a remote workstation having a browser for use by the entity to access sites over the internet;
a communicator operated by the service provider as a site on the internet;
an icon provided at the remote workstation for connecting the remote workstation with the communicator over the internet; and
a plurality of interconnected modules presented by the service provider at the communicator for access by the entity and for display at the base workstation, wherein each module contains a database and controls categorized aspects of the dynamic time-variable information.

9. A system as recited in claim 8 wherein the icon is customized with a logo provided by the service provider.

10. A system as recited in claim 8 wherein the icon includes login and password information regarding the entity.

11. A system as recited in claim 8 further comprising an auxiliary remote workstation for accessing the communicator when login and personal information regarding the entity, and URL information regarding the service provider are submitted to the communicator.

12. A system as recited in claim 8 further comprising a wireless remote workstation for accessing the communicator when login and personal information regarding the entity, and URL information regarding the service provider are submitted to the communicator.

13. A system as recited in claim 8 further comprising means at each module for accessing the database of another module.

14. A system as recited in claim 8 wherein selected aspects of the dynamic time-variable information are presented in appropriate modules, wherein each module includes information pertinent to a titled category, and further wherein the titled categories are taken from a group consisting of Customer Profile, Help/Request Desk, Customer Update, Customer File (file storage), Complaint Manager, Survey Manager, and Meeting Minutes.

15. A system as recited in claim 8 wherein a plurality of entities use the system, and the icon at the remote workstation of each entity directs the entity to a plurality of modules through the communicator, wherein the plurality of modules are dedicated to the particular entity.

16. An internet-based system for transferring dynamic time-variable information between a service provider and an entity, wherein the system comprises:
a plurality of modules, wherein each module has a database;
a means for dedicating pertinent time-variable information to a particular module, wherein the dynamic time-variable information pertains to the performance status of specific tasks undertaken by the service provider for the completion of a defined project;
a means at each module for accessing the database of other modules for performance of a task; and
a means for notifying the particular entity when the task is completed and whenever pertinent dedicated time-variable information has been updated.

17. A system as recited in claim 16 wherein the directing means is a communicator.

18. A system as recited in claim 17 wherein each module contains categorized aspects of the dynamic time-variable information.

19. A system as recited in claim 18 wherein selected aspects of the dynamic time-variable information are presented in appropriate modules with each module including information pertinent to a titled category, and further wherein the titled categories are taken from a group consisting of Customer Profile, Help/Request Desk, Customer Update, Customer File (file storage), Complaint Manager, Survey Manager, and Meeting Minutes.

20. A system as recited in claim 19 wherein the notifying means is an icon provided for use by the entity for connecting with the communicator and the system further comprises a means for causing the icon to blink whenever the dynamic, time-variable information is updated.
